(19) United States
(12) Patent Application Publication
(10) Pub. No.: US 2009/0255695 A1
(43) Pub. Date: Oct. 15, 2009

(54) POWER TOOL

(75) Inventors: Matthew Robert Breneman, Lawrenceville, GA (US); Kirk Alan Turner, Littleton, CO (US)

Correspondence Address: GEORGE R. REARDON, 3356 STATION COURT, LAWRENCVILLE, GA, 30044, US

(73) Assignee: ORIGINAL POWER, INC., Duluth, GA (US)

(21) Appl. No.: 12/099,786

(22) Filed: Apr. 9, 2008

(51) Int. Cl. A01D 15/00

(52) U.S. Cl. 172/15

(57) ABSTRACT

A lawn edger operable to minimize storage space, have a completely removable blade guard, have a folding shaft, and have a convenient to operate edging depth adjustment, is disclosed. The removable blade guard incorporates a safety interlock that prevents operation of the motor and blade when the guard is removed. The lawn edger incorporates a pivoting, folding, shaft for compact storage, a removable blade guard for easy clean out and an easily adjustable front wheel for convenient edging depth adjustment.

### FIELD OF THE INVENTION

The technology described herein relates generally to the field of power tools and more particularly to power edgers.

### BACKGROUND OF THE INVENTION

Lawn edgers are well known in the art, however, existing devices have multiple problems. In general existing edgers take up too much storage space because of their long angled shaft and handle. In addition, the guard on conventional edgers becomes easily clogged with dirt and grass. Also some edgers use a complicated threaded clamp to hold the front wheel in various positions for adjusting edging depth. While selected edgers have provided a hinged door on the guard for clean out, this does not afford complete access to the blade area for cleaning. Additionally, while some edgers use a threaded knob adjustment it is not easy to manipulate and the response time could be faster. Finally, some edgers incorporate a liftable edging guide to prevent it from scraping on the ground that is less than desirable.

Patents that are directed to these and other problems include the following:

U.S. Pat. No. 5,065,567, issued to Wessel on Nov. 19, 1991, discloses an improved lawn edger which includes an edging disk mounted for straight line adjustment, on the wheel axle of a lawn mower, between stowed and operative positions. One-handed operation moves the edger between these positions and, additionally, totally removes the edger for close-in mowing. The operating handle extends above the mower deck for ease of operation, while the apparatus minimizes undue tortional forces on the wheel axle.

U.S. Pat. No. 6,301,866, issued to Marshall on Oct. 16, 2001, discloses a vegetation trimming and edging device which has an adjustable head that permits selective positioning between trimming and edging orientations. A shaft extends between the head and a handle. The head receives one end of the shaft. A coupling mechanism couples the head and shaft, and locks the head against rotational movement about the shaft. In particular, the coupling mechanism includes a locking structure and a bias mechanism. The bias mechanism urges the locking structure into engagement to prevent rotational movement of the head. Downward pressure applied to the head overcomes the bias, however, and disengages the locking mechanism for rotation of the head between trimming and edging modes. When the downward pressure is released, the locking mechanism is again engaged to lock the head in position for the desired operational mode.

U.S. Pat. No. 6,926,090, issued to Sergyeyendo on Aug. 9, 2005 discloses a housing assembly for a power edger which includes a housing, a door and a latching system. The door is coupled to the housing and movable between an open position and a closed position. The latching system includes a latch member that is coupled to one of the housing and the door and a ramp that is coupled to the other one of the housing and the door. Contact between the ramp and the latch member when the door is being closed against the housing causes the latch member to move to an unlatched condition so as to automatically align the latch member to a latch aperture. This permits the door to be fully closed without the need to manually operate the latch member.

While these patents and other previous methods have attempted to solve the problems that they addressed, none have utilized or disclosed a lawn edger operable to minimize storage space, have a completely removable blade guard, have a folding shaft, and have a convenient to operate edging depth adjustment, as does embodiments of the technology disclosed herein.

Therefore, a need exists for a lawn edger with these attributes and functionalities. The lawn edger according to embodiments of the technology described herein substantially departs from the conventional concepts and designs of the prior art. It can be appreciated that there exists a continuing need for a new and improved lawn edger which can be used commercially. In this regard, the technology described herein substantially fulfills these objectives.

The foregoing patent and other information reflect the state of the art of which the inventor is aware and are tendered with a view toward discharging the inventors' acknowledged duty of candor in disclosing information that may be pertinent to the patentability of the technology described herein. It is respectfully stipulated, however, that the foregoing patent and other information do not teach or render obvious, singly or when considered in combination, the inventors' claimed invention.

### BRIEF SUMMARY OF THE INVENTION

The technology described herein incorporates a pivoting shaft which swings to a relatively vertical position so that the edger occupies less space. The technology described herein incorporates a guard that can be removed completely from the edger for clean out by pushing a release button. This guard also incorporates a safety interlock that prevents operation of the motor and blade when the guard is removed. The technology described herein uses a spring lever to detent in various positions to adjust depth. The wheel of the lawn edger also has an additional position that lifts the unit enough so that the edging guide does not contact the ground while moving the lawn edger to its storage location.

In an exemplary embodiment the technology described herein is a motorized lawn edger incorporating a pivoting shaft for compact storage, a removable blade guard for easy clean out and an easily adjustable front wheel for convenient edging depth adjustment.

The motorized lawn edger has a folding shaft. The blade guard is completely removeable instead of being hinged. The adjustable front wheel responds quickly and is more convenient to operate than existing devices.

The pivoting handle consists of a 180 degree opposed spring loaded pins in the bottom end of the shaft that act as pivot pins for the shaft. The shaft is captured in a housing that allows movement of the shaft from the use position to the storage position. There is a sliding spring-loaded collar on the shaft that locks into the housing in both the use position and the storage position.

The removeable guard consists of a plastic guard housing, a release button with an integrated latch and a spring to keep the latch firmly in place. The guard housing has a small integrated protrusion that contacts a recessed lever for actualting a hidden safety interlock switch.

Two halves of the shaft release knob are assembled around the shaft. The two knob halves have features that protrude laterally through a slot in the shaft and join together forming a post on which an extension spring is afixed. The other end of the extension spring is attached to a connecting strap between the two pivot pins which extend out from the shaft. The shaft is then inserted into the shaft housing where the two pivot pins snap into pivot holes under spring force and integrated tabs on the shaft release knob drop into corresponding slots in the shaft housing. The guard is injection molded from thermoplastic. A compression spring is inserted into an integral pocket in the guard. The latch is then inserted over the spring and the assembly is held in place by a cover over the pocket. The guard is inserted over a mating feature on the housing of the edger where the latch interfaces with a retaining feature in the edger housing.

The swing arm of the front wheel is attached to a lever made of spring steel. The lever and wheel swing arm are then attached to a backing plate via a bolt that allows the swing arm and lever to pivot together to change the height of the front wheel. The backing plate has raised features that capture the spring lever when it is released. These features are spaced to allow various angles of rotation of the swing arm and spring lever.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a rear perspective view of a lawn edger, according to an embodiment of the technology;

FIG. 2 is a front perspective view of a lawn edger, according to an embodiment of the technology;

FIG. 3 is a bottom perspective view of a lawn edger, according to an embodiment of the technology;

FIG. 4 is an exploded view of a lawn edger, according to an embodiment of the technology;

FIG. 5 is a right side plan view of an edging depth adjustment, according to an embodiment of the technology;

FIG. 6 is a left side perspective view of an edging depth adjustment, according to an embodiment of the technology;

FIG. 7 is an exploded view of an edging depth adjustment, according to an embodiment of the technology;

FIG. 8 is a side perspective view of a lawn edger handle, according to an embodiment of the technology;

FIG. 9 is a bottom perspective view of a lawn edger handle, according to an embodiment of the technology;

FIG. 10 is an exploded view of a lawn edger handle, according to an embodiment of the technology;

FIG. 11 is an outside perspective view of a housing shield, according to an embodiment of the technology;

FIG. 12 is an inside perspective view of a housing shield, according to an embodiment of the technology;

FIG. 13 is a right side perspective view of a central housing, according to an embodiment of the technology;

FIG. 14 is a left side perspective view of a central housing, according to an embodiment of the technology;

FIG. 15 is an outside perspective view of a removable blade guard, according to an embodiment of the technology;

FIG. 16 is an inside perspective view of a removable blade guard, according to an embodiment of the technology;

FIG. 17 is a bottom perspective view of a removable blade guard, according to an embodiment of the technology;

FIG. 18 is an exploded view of a removable blade guard, according to an embodiment of the technology;

FIG. 19 is a perspective view of a motor assembly, according to an embodiment of the technology;

FIG. 20 is a perspective view of a shaft release knob, according to an embodiment of the technology;

FIG. 21 is an exploded view of a motorized edging unit, according to an embodiment of the technology;

FIG. 22 is a plan view of a shaft housing, according to an embodiment of the technology;

FIG. 23 is a partial exploded view of a shaft housing, according to an embodiment of the technology.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

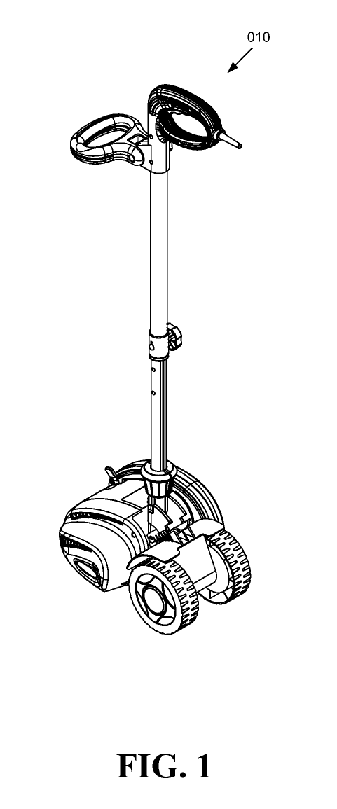

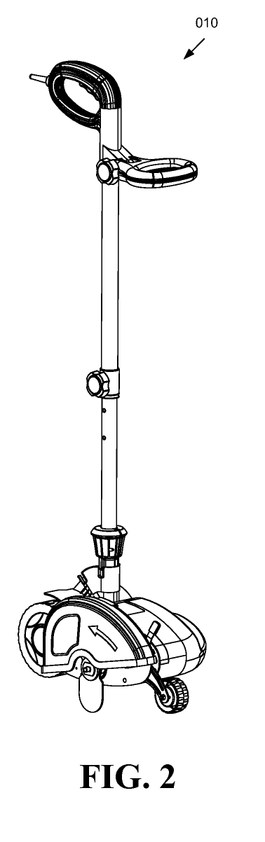

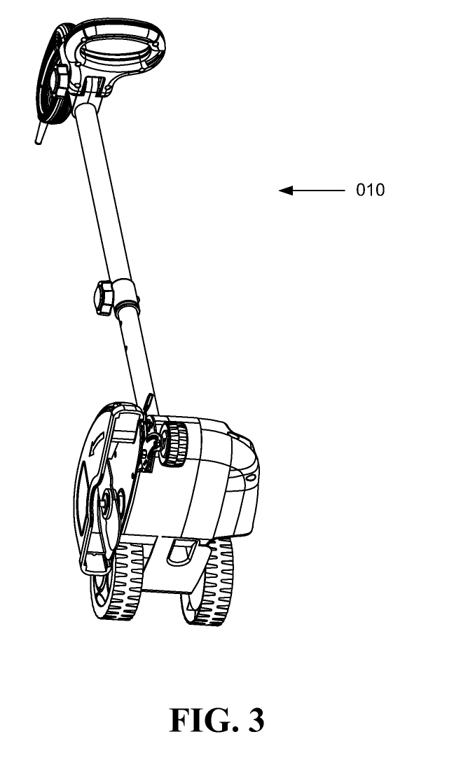

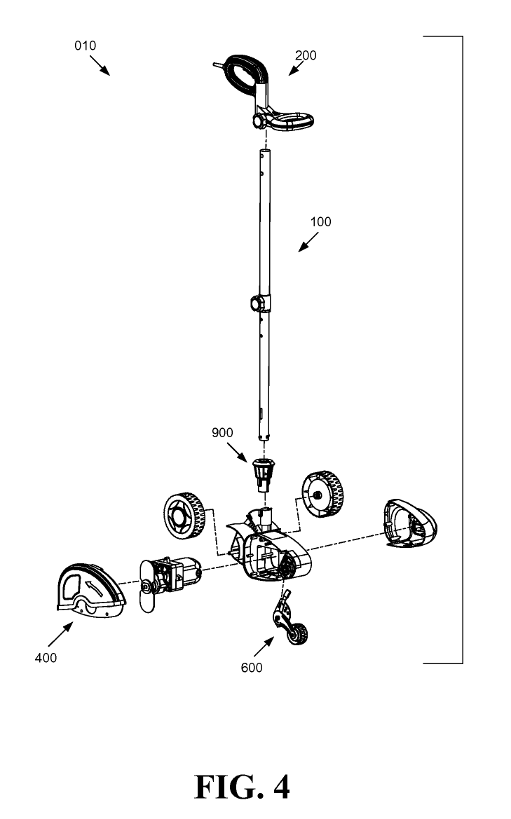

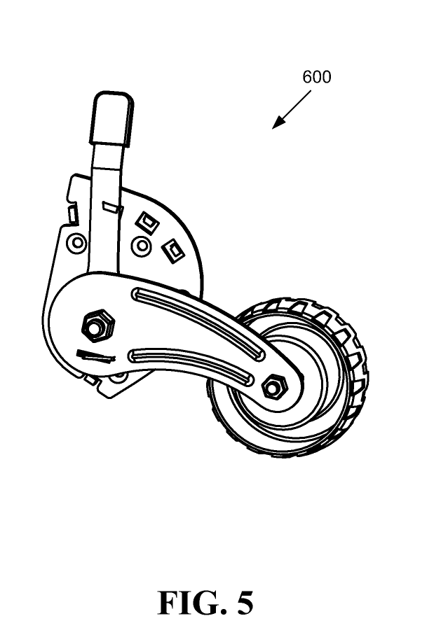

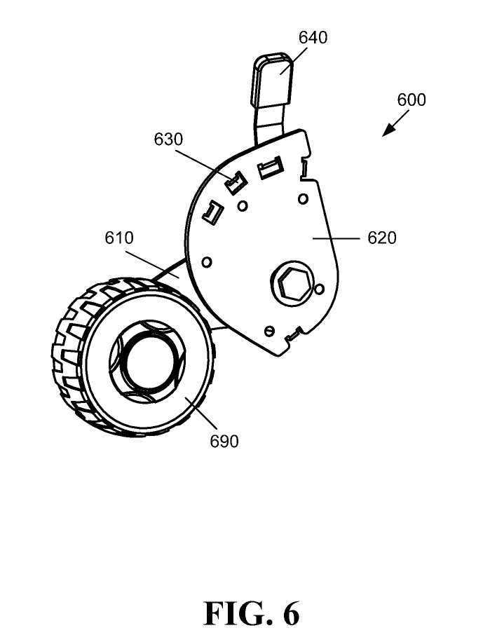

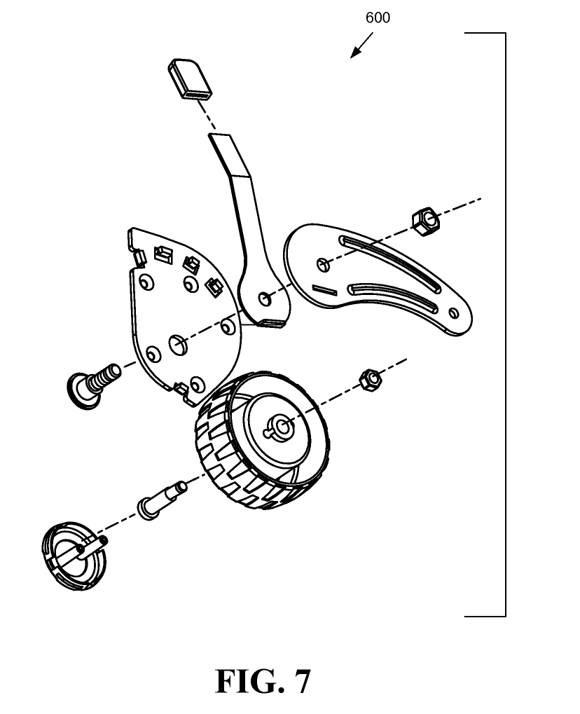

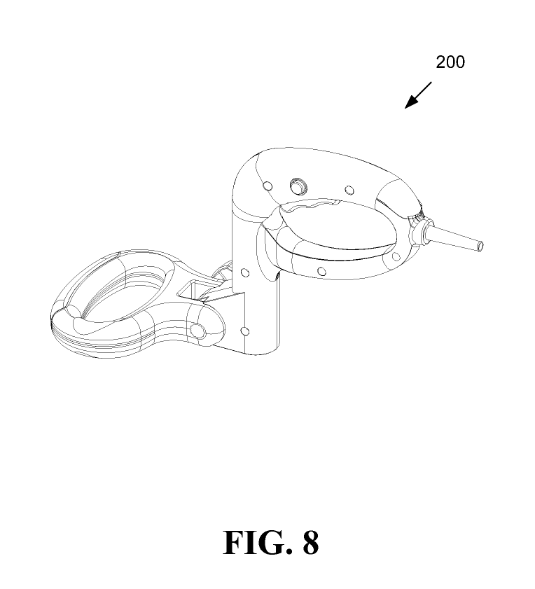

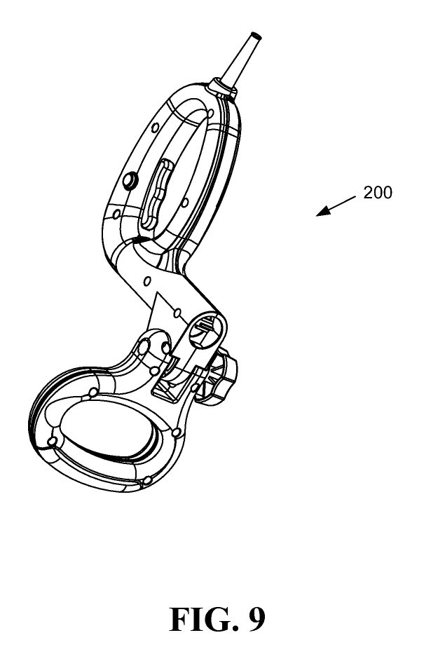

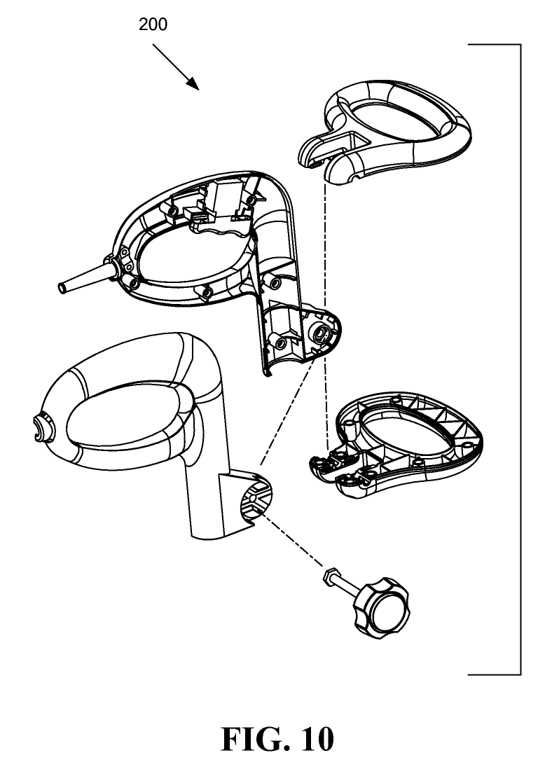

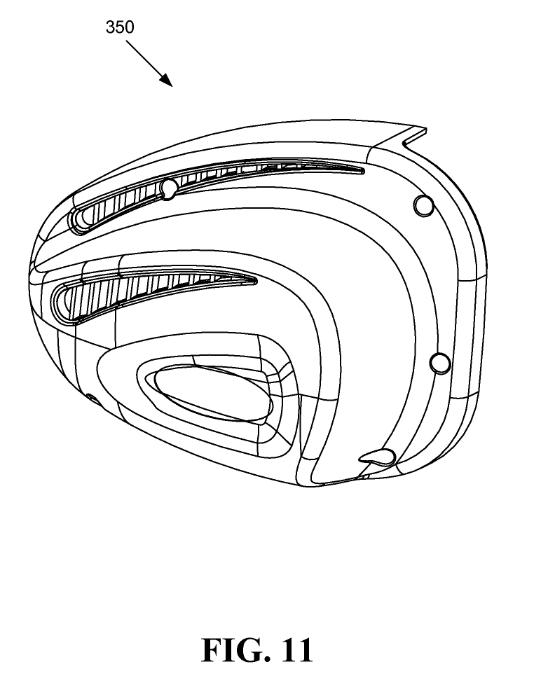

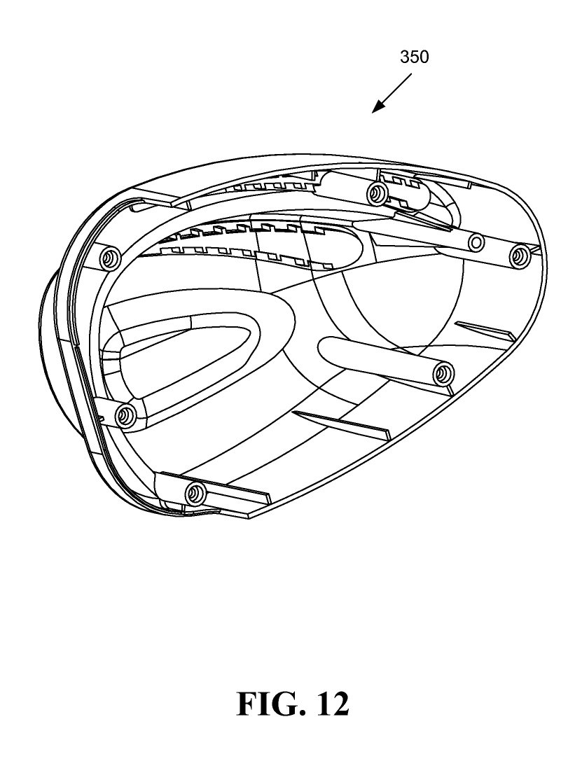

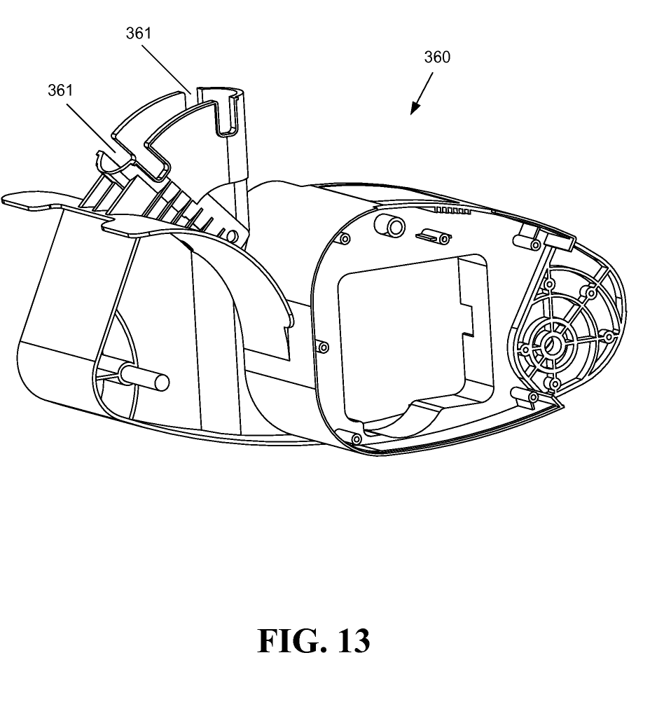

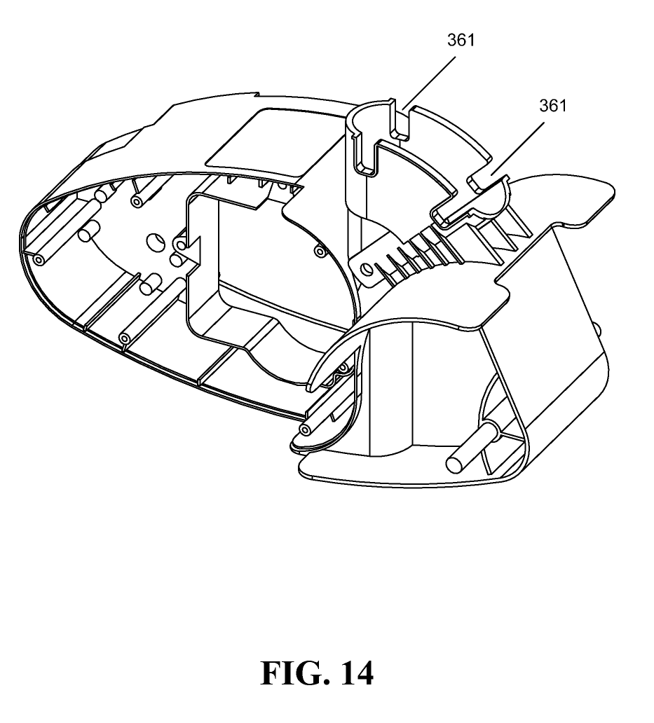

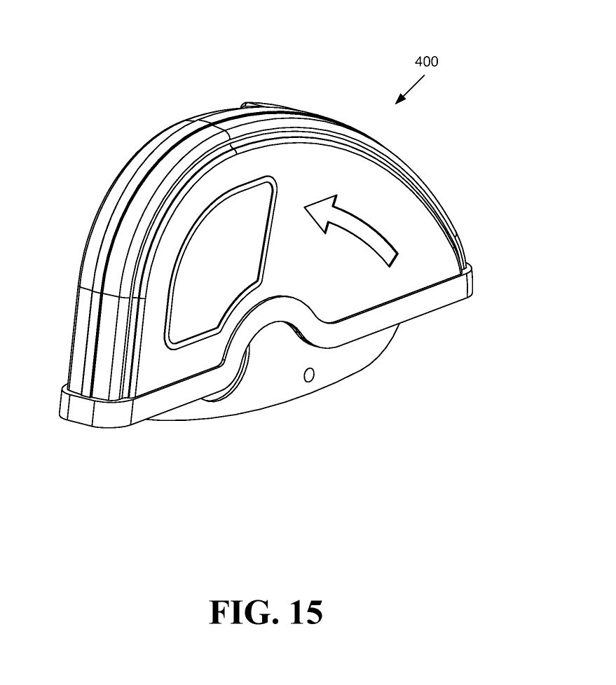

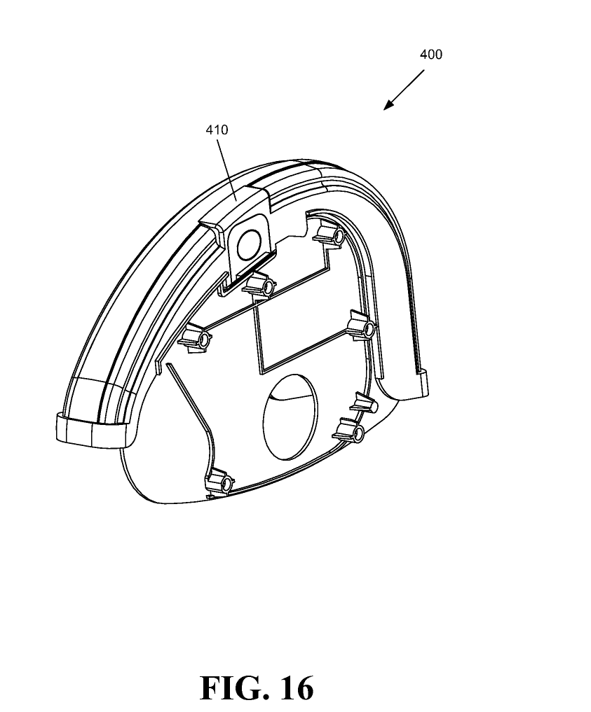

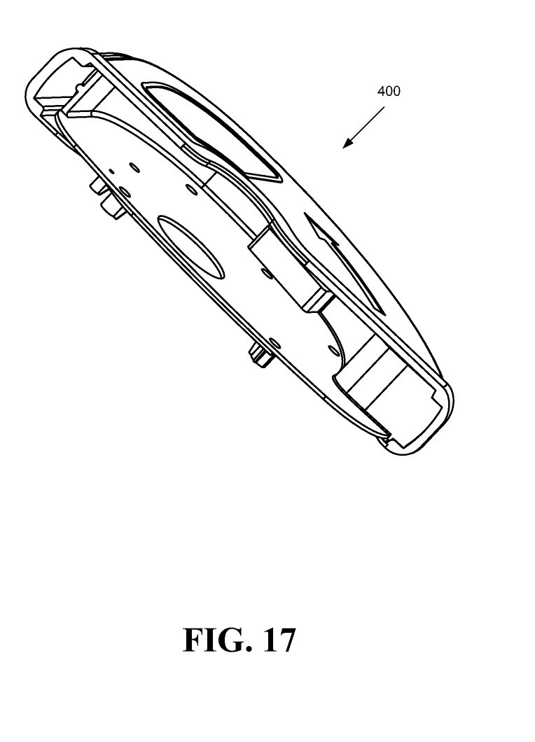

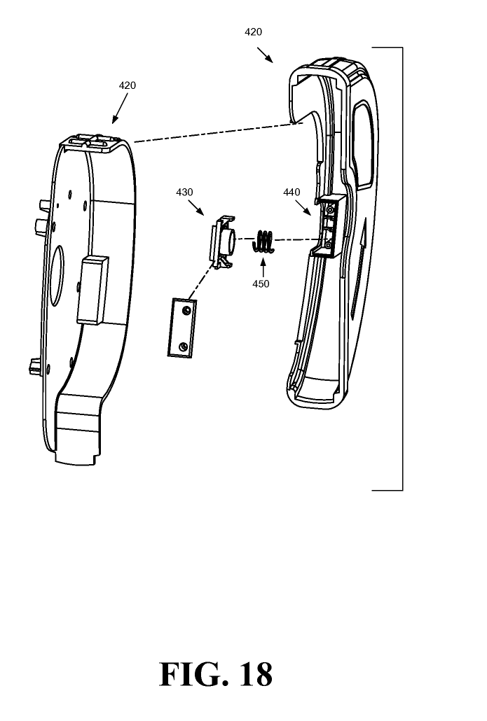

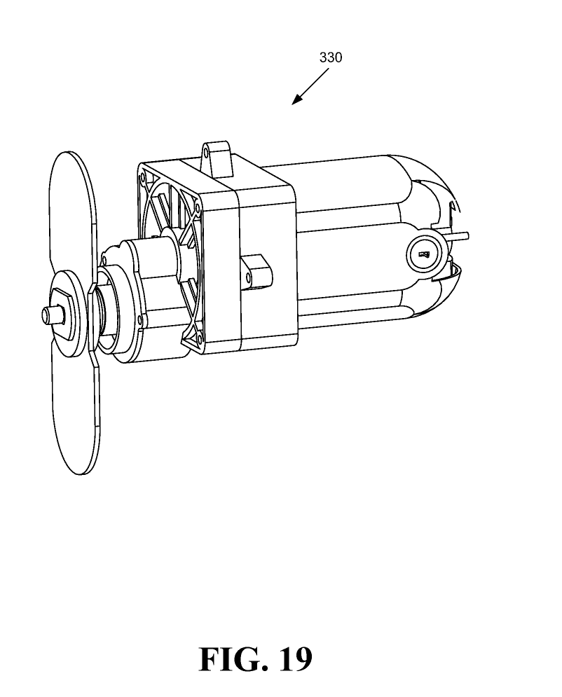

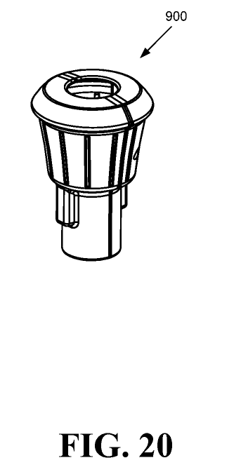

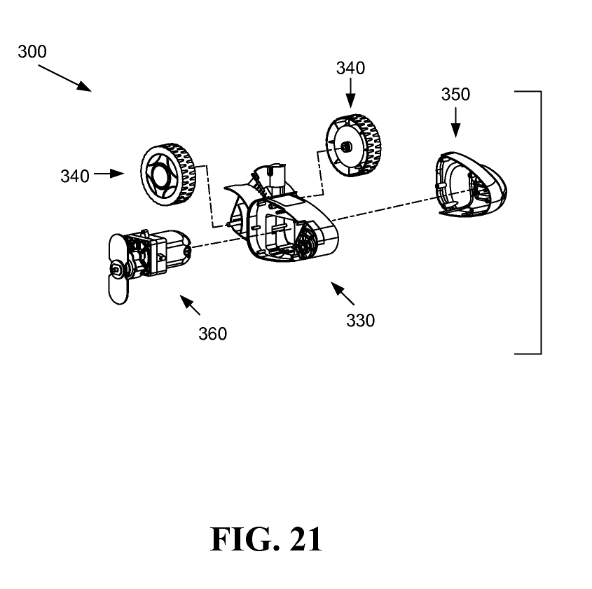

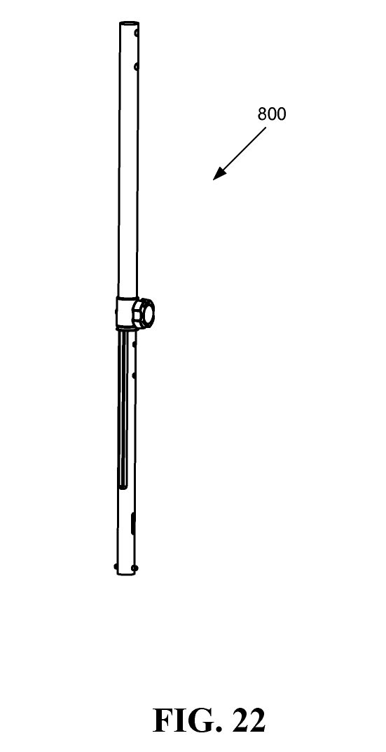

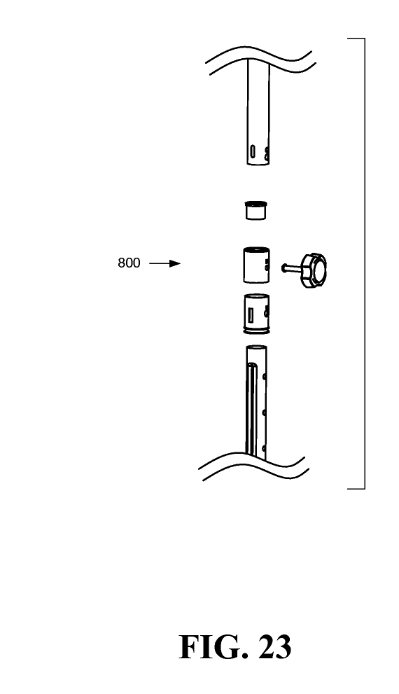

Referring now to FIGS. 1-23, a lawn edger 010 is shown comprising a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010. The lawn edger 010 further comprises a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained. The motorized edging unit 300 is comprised of a central housing 330, a motor assembly 360 that is connected to the central housing, a housing shield 350 that attaches to the central housing 330, and two of a wheel 340 which attaches to the central housing 330.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, an adjustable front wheel 690 located on the motorized edging unit 300 to provide for an edging depth adjustment 600, the adjustable front wheel 690 being movable by an edging depth adjuster 640 as selected by an operator.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, a shaft housing 800 located on the motorized edging unit 300 configured with a plurality of shaft housing slots 361 to receive a lower end of the pivotable shaft 100 at one of the plurality of angles for varied use in operation and for compact storage; and a shaft release knob 900 with which the operator lifts in order to release the pivotable shaft 100 from its present position and to move it to another of the plurality of angles for varied use in operation and for compact storage.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, a shaft housing 800 located on the motorized edging unit 300 configured with a plurality of shaft housing slots 361 to receive a lower end of the pivotable shaft 100 at one of the plurality of angles for varied use in operation and for compact storage; a shaft release knob 900 with which the operator lifts in order to release the pivotable shaft 100 from its present position and to move it to another of the plurality of angles for varied use in operation and for compact storage, an extension spring to provide tension between the shaft release knob 900, pivotable shaft 100, and the shaft housing 800; the shaft release knob 900 further comprising two halves of the shaft release knob 900 assembled around a diameter of the pivotable shaft 100, wherein a portion of at least one knob half protrudes laterally through a slot in the pivotable shaft 100, enabling the two halves to be joined to one another, thereby forming a post upon which an upper end of the extension spring is affixed; the pivotable shaft 100 further comprising a plurality of spring-loaded pivot pins extending out of the lower end of the pivotable shaft 100 and a strap connected under tension between the plurality of spring-loaded pivot pins, the strap thereby configured to receive a lower end of the extension spring; and the shaft housing 800 further comprising a plurality of pivot holes to receive the plurality of pivot pins of the pivotable shaft 100 and hold the pivotable shaft 100 in place.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, wherein the pivotable shaft 100 is configured to pivot about the motorized edging unit 300 at a plurality of angles between 0 and 180 degrees, relative to the ground, for varied use in operation and for compact storage of the lawn edger 010.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010., a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained, a removable blade guard housing 420; an integrated latch 430 located on the single push-button release 410; a compression spring 450 inserted into an integral pocket 440 located within the removable blade guard 400 to keep the integrated latch 430 firmly in place; and wherein the removable blade guard 400 is removed by pressing the single push-button release 410 and lifting the removable blade guard 400 away from the lawn edger 010.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained, a removable blade guard housing 420; an integrated latch 430 located on the single push-button release 410; a compression spring 450 inserted into an integral pocket 440 located within the removable blade guard 400 to keep the integrated latch 430 firmly in place; and wherein the removable blade guard 400 is removed by pressing the single push-button release 410 and lifting the removable blade guard 400 away from the lawn edger 010, wherein the removable blade guard housing 420 further comprises: a small integrated protrusion located on the removable blade guard housing 420 that contacts a recessed lever for actuating an inconspicuous safety interlock switch, the safety interlock switch operable between the removable blade guard 400 and the motorized edging unit 300 to prevent operation of the lawn edger 010 when the removable blade guard 400 is in a removed state.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained, wherein the removable blade guard 400 is comprised of a thermoplastic injection molding.

In an embodiment of the technology described herein the lawn edger 010 comprises a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010, an adjustable front wheel 690 located on the motorized edging unit 300 to provide for an edging depth adjustment 600, the adjustable front wheel 690 being movable by an edging depth adjuster 640 as selected by an operator, a swing arm 610 upon which the adjustable front wheel 690 is mounted and is adjusted; a spring lever 640 attached to the swing arm 610 and configured for adjustment by an operator of the lawn edger 010; and a backing plate 620 upon which the swing arm 610 and spring lever 640 are attached to allow the swing arm 610 and the spring lever 640 to pivot together when adjusted by the operator and thereby change the height of the adjustable front wheel 600, the backing plate 620 having a plurality of raised slots 630 to capture the spring lever 640 when it is released, thereby providing a plurality of angles of rotation of the swing arm 610 and the spring lever 640.

The technology described herein is also directed to methods of using and storing the lawn edger 010, as well as methods of cleaning and maintaining the lawn edger 010. In one embodiment of the technology described herein a method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010.

In an embodiment of the technology described herein the method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010; utilizing a lawn edger 010 further comprising: an adjustable front wheel 600 located on the motorized edging unit 300 to provide for an edging depth adjustment, the adjustable front wheel 690 being movable by an edging depth adjuster 600 as selected by an operator; and placing the adjustable front wheel 690 at a desired height relative to the motorized edging unit 300 to set a depth at which edging occurs; operating the lawn edger 010 with the adjustable front wheel 690 of the motorized edging unit 300 at the desired height; and changing the height of the adjustable front wheel 690 based as needed to set the depth at which edging occurs.

In an embodiment of the technology described herein the method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010; utilizing a lawn edger 010 further comprising: a shaft housing 800 located on the motorized edging unit 300 configured with a plurality of shaft housing slots 361 to receive a lower end of the pivotable shaft 100 at one of the plurality of angles for varied use in operation and for compact storage; and a shaft release knob 900 with which the operator lifts in order to release the pivotable shaft 100 from its present position and to move it to another of the plurality of angles for varied use in operation and for compact storage; grasping and lifting the shaft release knob 900 upwardly out of the shaft housing 800 and along the pivotable shaft 100 to release the pivotable shaft 100 from its present position in the shaft housing 800 and to move the pivotable shaft 100 to another of the plurality of angles for varied use in operation and for compact storage; and releasing the shaft release knob 900 once the pivotable shaft 100 is placed in another of the plurality of angles for varied use in operation and for compact storage.

In an embodiment of the technology described herein the method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010; utilizing a lawn edger 010 further comprising: a shaft housing 800 located on the motorized edging unit 300 configured with a plurality of shaft housing slots 361 to receive a lower end of the pivotable shaft 100 at one of the plurality of angles for varied use in operation and for compact storage; and a shaft release knob 900 with which the operator lifts in order to release the pivotable shaft 100 from its present position and to move it to another of the plurality of angles for varied use in operation and for compact storage; grasping and lifting the shaft release knob 900 upwardly out of the shaft housing 800 and along the pivotable shaft 100 to release the pivotable shaft 100 from its present position in the shaft housing 800 and to move the pivotable shaft 100 to another of the plurality of angles for varied use in operation and for compact storage; and releasing the shaft release knob 900 once the pivotable shaft 100 is placed in another of the plurality of angles for varied use in operation and for compact storage; utilizing a lawn edger 010 further comprising: an extension spring to provide tension between the shaft release knob 900, pivotable shaft 100, and the shaft housing 800; the shaft release knob 900 further comprising two halves of the shaft release knob 900 assembled around a diameter of the pivotable shaft 100, wherein a portion of at least one knob half protrudes laterally through a slot in the pivotable shaft 100, enabling the two halves to be joined to one another, thereby forming a post upon which an upper end of the extension spring is affixed; the pivotable shaft 100 further comprising a plurality of spring-loaded pivot pins extending out of the lower end of the pivotable shaft 100 and a strap connected under tension between the plurality of spring-loaded pivot pins, the strap thereby configured to receive a lower end of the extension spring; and the shaft housing 800 further comprising a plurality of pivot holes to receive the plurality of pivot pins of the pivotable shaft 100 and hold the pivotable shaft 100 in place; grasping and lifting the shaft release knob 900, that is under tension from the spring-loaded pivot pins, upwardly out of the shaft housing 800, and any of the plurality of pivot holes, and along the pivotable shaft 100 to release the pivotable shaft 100 from its present position in the shaft housing 800 and to move the pivotable shaft 100 to another of the plurality of angles for varied use in operation and for compact storage; and releasing the shaft release knob 900 once the pivotable shaft 100 is placed in another of the plurality of angles for varied use in operation and for compact storage, the shaft release knob 900, that is under tension from the spring-loaded pivot pins, returning to a position securing the pivotable shaft 100.

In an embodiment of the technology described herein the method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010; wherein the pivotable shaft 100 is configured to pivot about the motorized edging unit 300 at a plurality of angles between 0 and 180 degrees, relative to the ground, for varied use in operation and for compact storage of the lawn edger 010.

In an embodiment of the technology described herein the method for using and storing a lawn edger 010 comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010; utilizing a lawn edger 010 further comprising: an adjustable front wheel 600 located on the motorized edging unit 300 to provide for an edging depth adjustment, the adjustable front wheel 600 being movable by an edging depth adjuster 600 as selected by an operator; and placing the adjustable front wheel 690 at a desired height relative to the motorized edging unit 300 to set a depth at which edging occurs; operating the lawn edger 010 with the adjustable front wheel 690 of the motorized edging unit 300 at the desired height; and changing the height of the adjustable front wheel 600 based as needed to set the depth at which edging occurs; utilizing a lawn edger 010 further comprising: a swing arm 610 upon which the adjustable front wheel 690 is mounted and is adjusted; a spring lever 640 attached to the swing arm 610 and configured for adjustment by an operator of the lawn edger 010; and a backing plate 620 upon which the swing arm 610 and spring lever 640 are attached to allow the swing arm 610 and the spring lever 640 to pivot together when adjusted by the operator and thereby change the height of the adjustable front wheel 690, the backing plate 620 having a plurality of raised slots 630 to capture the spring lever 640 when it is released, thereby providing a plurality of angles of rotation of the swing arm 610 and the spring lever 640; selecting a desired height of the adjustable front wheel 690 of the lawn edger 010; and placing the spring lever 640 in one of the raised slots 630 of the backing plate 620 to maintain the adjustable front wheel 690 in place at the desired height.

In an embodiment of the technology described herein a method for cleaning and maintaining a lawn edger 010 comprises: utilizing a lawn edger 010 comprising: a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained; removing the removable blade guard 400 by an operator for cleaning and maintenance of the lawn edger 010; and providing accessibility to the motorized edging unit 300. This method further comprises: utilizing a lawn edger 010 further comprising: a removable blade guard housing 420; an integrated latch 430 located on the single push-button release 410; and a compression spring 450 inserted into an integral pocket 440 located within the removable blade guard 400 to keep the integrated latch 430 firmly in place; and removing the removable blade guard 400 by pressing the single push-button release 410 and lifting the removable blade guard 400 away from the lawn edger 010.

In an embodiment of the technology described herein the method for cleaning and maintaining a lawn edger 010 comprises: utilizing a lawn edger 010 comprising: a removable blade guard 400, the removable blade guard 400 being entirely separable from the lawn edger 010 with a single push-button release 410, the removable blade guard 400 configured to provide accessibility to the motorized edging unit 300 and to allow the lawn edger 010 to be cleaned and maintained; removing the removable blade guard 400 by an operator for cleaning and maintenance of the lawn edger 010; and providing accessibility to the motorized edging unit 300; utilizing a lawn edger 010 further comprising: a small integrated protrusion located on the removable blade guard housing 420 that contacts a recessed lever for actuating an inconspicuous safety interlock switch, the safety interlock switch operable between the removable blade guard 400 and the motorized edging unit 300 to prevent operation of the lawn edger 010 when the removable blade guard 400 is in a removed state; and automatically actuating the safety interlock switch as the removable blade guard 400 is removed, thereby inactivating the lawn edger 010.

In an embodiment of the technology described herein the method for using and storing a lawn edger 010 further comprises: utilizing a lawn edger 010 comprising: a pivotable shaft 100 for operational adjustability and compact storage of the lawn edger 010, the pivotable shaft 100 being generally cylindrical and located between a handle 200 and a motorized edging unit 300, the pivotable shaft 100 configured to pivot about the motorized edging unit 300 at a plurality of angles for varied use in operation and for compact storage of the lawn edger 010; pivoting the pivotable shaft 100 to a desired angle of use relative to the ground; operating the lawn edger 010 with the pivotable shaft 100 at the desired angle of use relative to the ground by placing the pivotable shaft 100 at the desired angle of use; and storing the lawn edger 010 by raising the pivotable shaft 100 to a generally ninety degree angle relative to the ground, thereby reducing the horizontal space required to store the lawn edger 010, wherein the removable blade guard 400 is comprised of a thermoplastic injection molding.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A lawn edger comprising:
a pivotable shaft for operational adjustability and compact storage of the lawn edger, the pivoting shaft being generally cylindrical and located between a handle and a motorized edging unit, the pivoting shaft configured to pivot about the motorized edging unit at a plurality of angles for varied use in operation and for compact storage of the lawn edger.

2. The lawn edger of claim 1, further comprising:
a removable blade guard, the removable blade guard being entirely separable from the lawn edger with a single push-button release, the removable blade guard configured to provide accessibility to the motorized edging unit and to allow the lawn edger to be cleaned and maintained.

3. The lawn edger of claim 1, further comprising:
an adjustable front wheel located on the motorized edging unit to provide for an edging depth adjustment, the adjustable front wheel being movable by an edging depth adjuster as selected by an operator.

4. The lawn edger of claim 1, further comprising:
a shaft housing located on the motorized edging unit configured with a plurality of shaft housing slots to receive a lower end of the pivotable shaft at one of the plurality of angles for varied use in operation and for compact storage; and
a shaft release knob with which the operator lifts in order to release the pivotable shaft from its present position and to move it to another of the plurality of angles for varied use in operation and for compact storage.

5. The lawn edger of claim 4, further comprising:
an extension spring to provide tension between the shaft release knob, pivotable shaft, and the shaft housing;
the shaft release knob further comprising two halves of the shaft release knob assembled around a diameter of the pivotable shaft, wherein a portion of at least one knob half protrudes laterally through a slot in the pivotable shaft, enabling the two halves to be joined to one another, thereby forming a post upon which an upper end of the extension spring is affixed;
the pivotable shaft further comprising a plurality of spring-loaded pivot pins extending out of the lower end of the pivotable shaft and a strap connected under tension between the plurality of spring-loaded pivot pins, the strap thereby configured to receive a lower end of the extension spring; and
the shaft housing further comprising a plurality of pivot holes to receive the plurality of pivot pins of the pivotable shaft and hold the pivotable shaft in place.

6. The lawn edger of claim 1, wherein the pivotable shaft is configured to pivot about the motorized edging unit at a plurality of angles between 0 and 180 degrees, relative to the ground, for varied use in operation and for compact storage of the lawn edger.

7. The lawn edger of claim 2, further comprising:
a removable blade guard housing;
an integrated latch located on the single push-button release;
a compression spring inserted into an integral pocket located within the removable blade guard to keep the integrated latch firmly in place; and
wherein the removable blade guard is removed by pressing the single push-button release and lifting the removable blade guard away from the lawn edger.

8. The lawn edger of claim 7, wherein the removable blade guard housing further comprises:
a small integrated protrusion located on the removable blade guard housing that contacts a recessed lever for actuating an inconspicuous safety interlock switch, the safety interlock switch operable between the removable blade guard and the motorized edging unit to prevent operation of the lawn edger when the removable blade guard is in a removed state.

9. The lawn edger of claim 2, wherein the removable blade guard is comprised of a thermoplastic injection molding.

10. The lawn edger of claim 3, further comprising:
a swing arm upon which the adjustable front wheel is mounted and is adjusted;
a spring lever attached to the swing arm and configured for adjustment by an operator of the lawn edger; and
a backing plate upon which the swing arm and spring lever are attached to allow the swing arm and the spring lever to pivot together when adjusted by the operator and thereby change the height of the adjustable front wheel, the backing plate having a plurality of raised slots to capture the spring lever when it is released, thereby providing a plurality of angles of rotation of the swing arm and the spring lever.

11. A method for using and storing a lawn edger, the method comprising:
utilizing a lawn edger comprising:
a pivotable shaft for operational adjustability and compact storage of the lawn edger, the pivoting shaft being generally cylindrical and located between a handle and a motorized edging unit, the pivoting shaft configured to pivot about the motorized edging unit at a plurality of angles for varied use in operation and for compact storage of the lawn edger;
pivoting the pivotable shaft to a desired angle of use relative to the ground;
operating the lawn edger with the pivotable shaft at the desired angle of use relative to the ground by placing the pivotable shaft at the desired angle of use; and
storing the lawn edger by raising the pivotable shaft to a generally ninety degree angle relative to the ground, thereby reducing the horizontal space required to store the lawn edger.

12. The method for using and storing a lawn edger of claim 11, the method further comprising:
utilizing a lawn edger further comprising:
an adjustable front wheel located on the motorized edging unit to provide for an edging depth adjustment, the adjustable front wheel being movable by an edging depth adjuster as selected by an operator; and
placing the adjustable front wheel at a desired height relative to the motorized edging unit to set a depth at which edging occurs;
operating the lawn edger with the adjustable front wheel of the motorized edging unit at the desired height; and
changing the height of the adjustable front wheel based as needed to set the depth at which edging occurs.

13. The method for using and storing a lawn edger of claim 11, the method further comprising:
utilizing a lawn edger further comprising:
a shaft housing located on the motorized edging unit configured with a plurality of shaft housing slots to receive a lower end of the pivotable shaft at one of the plurality of angles for varied use in operation and for compact storage; and
a shaft release knob with which the operator lifts in order to release the pivotable shaft from its present position and to move it to another of the plurality of angles for varied use in operation and for compact storage;
grasping and lifting the shaft release knob upwardly out of the shaft housing and along the pivotable shaft to release the pivotable shaft from its present position in the shaft housing and to move the pivotable shaft to another of the plurality of angles for varied use in operation and for compact storage; and
releasing the shaft release knob once the pivotable shaft is placed in another of the plurality of angles for varied use in operation and for compact storage.

14. The method for using and storing a lawn edger of claim 13, the method further comprising:
utilizing a lawn edger further comprising:
an extension spring to provide tension between the shaft release knob, pivotable shaft, and the shaft housing;
the shaft release knob further comprising two halves of the shaft release knob assembled around a diameter of the pivotable shaft, wherein a portion of at least one knob half protrudes laterally through a slot in the pivotable shaft, enabling the two halves to be joined to one another, thereby forming a post upon which an upper end of the extension spring is affixed;
the pivotable shaft further comprising a plurality of spring-loaded pivot pins extending out of the lower end of the pivotable shaft and a strap connected under tension between the plurality of spring-loaded pivot pins, the strap thereby configured to receive a lower end of the extension spring; and
the shaft housing further comprising a plurality of pivot holes to receive the plurality of pivot pins of the pivotable shaft and hold the pivotable shaft in place;
grasping and lifting the shaft release knob, that is under tension from the spring-loaded pivot pins, upwardly out of the shaft housing, and any of the plurality of pivot holes, and along the pivotable shaft to release the pivotable shaft from its present position in the shaft housing and to move the pivotable shaft to another of the plurality of angles for varied use in operation and for compact storage; and
releasing the shaft release knob once the pivotable shaft is placed in another of the plurality of angles for varied use in operation and for compact storage, the shaft release knob, that is under tension from the spring-loaded pivot pins, returning to a position securing the pivotable shaft.

15. The method for using and storing a lawn edger of claim 11, wherein the pivotable shaft is configured to pivot about the motorized edging unit at a plurality of angles between 0 and 180 degrees, relative to the ground, for varied use in operation and for compact storage of the lawn edger.

16. The method for using and storing a lawn edger of claim 12, the method further comprising:
utilizing a lawn edger further comprising:
a swing arm upon which the adjustable front wheel is mounted and is adjusted;
a spring lever attached to the swing arm and configured for adjustment by an operator of the lawn edger; and
a backing plate upon which the swing arm and spring lever are attached to allow the swing arm and the spring lever to pivot together when adjusted by the operator and thereby change the height of the adjustable front wheel, the backing plate having a plurality of raised slots to capture the spring lever when it is released, thereby providing a plurality of angles of rotation of the swing arm and the spring lever;
selecting a desired height of the adjustable front wheel of the lawn edger; and
placing the spring lever in one of the raised slots of the backing plate to maintain the adjustable front wheel in place at the desired height.

17. A method for cleaning and maintaining a lawn edger, the method comprising:
utilizing a lawn edger comprising:
a removable blade guard, the removable blade guard being entirely separable from the lawn edger with a single push-button release, the removable blade guard configured to provide accessibility to the motorized edging unit and to allow the lawn edger to be cleaned and maintained;
removing the removable blade guard by an operator for cleaning and maintenance of the lawn edger; and
providing accessibility to the motorized edging unit.

18. The method for cleaning and maintaining a lawn edger of claim 17, the method further comprising:
utilizing a lawn edger further comprising:
a removable blade guard housing;
an integrated latch located on the single push-button release; and
a compression spring inserted into an integral pocket located within the removable blade guard to keep the integrated latch firmly in place; and
removing the removable blade guard by pressing the single push-button release and lifting the removable blade guard away from the lawn edger.

19. The method for cleaning and maintaining a lawn edger of claim 17, the method further comprising:
utilizing a lawn edger further comprising:
a small integrated protrusion located on the removable blade guard housing that contacts a recessed lever for actuating an inconspicuous safety interlock switch, the safety interlock switch operable between the removable blade guard and the motorized edging unit to prevent operation of the lawn edger when the removable blade guard is in a removed state; and
automatically actuating the safety interlock switch as the removable blade guard is removed, thereby inactivating the lawn edger.

20. The method for using and storing a lawn edger of claim 11, wherein the removable blade guard is comprised of a thermoplastic injection molding.
